(19) United States
(12) Patent Application Publication
(10) Pub. No.: US 2017/0274232 A1
(43) Pub. Date: Sep. 28, 2017

(54) FIRE PROTECTION SYSTEMS AND METHODS

(71) Applicant: Chris Kreuser, Westerville, OH (US)

(72) Inventor: Chris Kreuser, Westerville, OH (US)

(21) Appl. No.: 15/466,408

(22) Filed: Mar. 22, 2017

Related U.S. Application Data
(60) Provisional application No. 62/312,104, filed on Mar. 23, 2016.

(51) Int. Cl. A62C 3/02; A62C 3/07; A62C 2/10

(52) U.S. Cl. CPC A62C 3/0257; A62C 2/10; A62C 3/0214; A62C 3/07

(57) ABSTRACT

Modular fire protection systems and associated methods of installation for protecting structures and/or vehicles from wildfire damage. Exemplary fire protection systems for protecting structures will typically include at least one palletized fire wrap panel for deployment on the roof of the structure.

### CROSS-REFERENCE TO RELATED APPLICATIONS

This application claims the benefit of U.S. Provisional Application No. 62/312,104, filed on Mar. 23, 2016, which is hereby incorporated by reference as if fully recited herein.

### TECHNICAL FIELD

Exemplary system and method embodiments described herein relate to protecting structures and/or other property from fire damage.

### BACKGROUND

On average, wildfires destroy thousands of homes and correspondingly displace tens of thousands of people every year, resulting in millions of dollars in property damage and in countless other monetary and emotional costs associated with the displaced families. In some years, the devastation is even worse. For example, 2015 was one of the worst wildfire seasons in U.S. history, resulting in billions of dollars in damage and destroying over 10,000,000 acres of land.

Research and case studies have shown that the primary cause of a structure burning during a wildfire is the ignitability of the structure. That is, most structures—especially residential structures—are constructed of materials that are highly susceptible to ignition by the radiant heat, convective heat, and/or blowing firebrands (burning pieces of wood) that are typically produced during a wildfire. Ignition of a structure may also be facilitated, for example, when nearby fuels become ignited.

Known systems and products for protecting structures against the effects of a wildfire are currently available. Such existing systems/products include, for example, water gels, coatings, and wraps. However, each of these existing systems/products has one or more disadvantages. For example, some of the disadvantages associated with existing house wraps include, without limitation, high cost, non-reusability and poor strength. Existing house wraps also require a great deal of labor to install without damaging the structure being protected.

Consequently, it can be understood that there is an unmet need for a system and method of protecting structures against wildfires that overcomes the disadvantages of existing systems and methods. There is a similar unmet need for a system and method of protecting vehicles against wildfires. Exemplary fire protection system and method embodiments described herein fulfill this need.

### SUMMARY

Exemplary fire protection system and method embodiments described herein combine various material technologies with an innovative, reusable method of application that provides for the ability to protect structures against fire damage in a more effective and more efficient manner than has heretofore been possible. For example, it is anticipated that protection of a typical residential home against wildfire damage according to exemplary system and method embodiments described herein, may be accomplished by a small group of installers in as little as 2-3 hours.

Exemplary fire protection system embodiments described herein comprise, generally speaking, a novel, full-house fire-resistant wrap, that is adaptable for use with residential (and other) structures of virtually any size and shape. Installation of the wrap may be accomplished quickly and efficiently, and without nailing, stapling, screwing, or otherwise fastening the wrap to the structure in a damaging manner. Furthermore, exemplary system and method embodiments allow installers to avoid standing or walking on the roof of a structure to be protected, as the components of an exemplary system may be installed from a bucket truck, lift, ladder, or combinations thereof. Consequently, the likelihood of damage to the structure to be protected and the risk of injury to the installation personnel is considerably lessened.

Exemplary fire protection system embodiments described herein may include, among other components, a fire-resistant wrap attached in a storable manner to a specialized pallet that may be easily lifted and set onto the roof of a structure to be protected. The nature of the pallets allows the pallet and attached wrap to rest securely on the roof of the structure, such as in a position straddling a roof peak.

Multiple pallet-mounted wraps may be placed at various locations on the roof of a structure to be protected, such as by way of a boom truck or other lifting apparatus, such that when unrolled, the individual wraps will form panels that may be detachably connected to form a substantially continuous fireproof wrap over the entirety of the structure. The ends of a structure not coverable by a palletized wrap may instead be covered by fire wrap side panels that may be detachably connected to the palletized fire wrap panels. Structure portions having unique shapes and/or locations that make coverage by a palletized wrap difficult may be covered by separate wrap panels or by wrap components having predefined shapes. For example, and without limitation, wrap material may be fully or partially pre-formed as a chimney or vent sock to be slid over the top of a chimney or vent and subsequently joined to an adjacent wrap panel(s).

Once the various individual wrap panels and/or other wrap components are unrolled/placed or joined with other panels, the panels are strapped or otherwise securely affixed to the underlying structure in a non-damaging manner. Fire wrap panels may also be selected to have a length, or multiple panels may be combined, such that vegetation, fuels, and/or other ignitable materials located nearby the structure of interest may also be covered and protected against ignition. Joining of the various panels is accomplished in a manner that allows the resulting wrap to protect the underlying structure against the effects of direct flame contact, radiant and convective heat, and also against airborne firebrands—i.e., against all of the causes that collectively start over 95% of structure fires.

Exemplary fire protection system and method embodiments described herein include many features and provide for various functionality not found in known systems and methods for protecting structures against wildfires. For example, it is believed that an exemplary fire protection wrap embodiment as described herein may be installed over a structural area of given size much more quickly than any known house wrap. Additionally, while currently known house wraps are easily torn by structure edges and may be easily ripped by windblown debris, the heavy duty material used to construct the panels and other protective components of an exemplary fire protection wrap system as described herein, and the manner in which said panels are installed and secured to an underlying structure, allows the resulting wrap to perform better in high winds and against flying debris than known house wraps. In this regard, the material used to construct the panels and other protective components of at least some exemplary fire protection wrap system as described herein is much thicker than that of known house wraps, and may be resistive to temperatures of up to 3,000 degrees Fahrenheit. In contrast, current house wraps are lightweight and breakdown well below the average temperatures generated during a wildfire.

It is also anticipated that exemplary fire protection system embodiments as described herein may be installed equally or about as quickly as known spray foams. However, whereas know spray foams normally only offer fire protection for a few days, an exemplary fire protection system embodiment may be left in place to provide fire protection as long as necessary. Also, unlike spray foams, exemplary fire protection system embodiments are not degraded by windblown debris nor the temperatures produced by typical wildfires.

Unlike known house wraps, spray foams and other fire protection devices, the fire wrap panels and other components of an exemplary fire protection system embodiment as described herein are reusable and may be recovered after a given fire risk has ended for later use on the same or another structure. To this end, the modular nature of the exemplary system embodiments allows the system pallets to be easily lowered to the ground, whereafter the associated wrap panels may be inspected, rolled, folded, and re-secured to their corresponding pallets for future use.

Other aspects and features of the invention will become apparent to those skilled in the art upon review of the following detailed description of exemplary embodiments along with the accompanying drawing figures.

### BRIEF DESCRIPTION OF THE DRAWINGS

In the following descriptions of the drawings and exemplary embodiments, like reference numerals across the several views refer to identical or equivalent features, and:

FIG. 1A depicts one exemplary fire wrap panel of an exemplary fire protection system embodiment;

FIG. 1B depicts two exemplary fire wrap panels detachably joined together as part of an exemplary fire protection system embodiment;

FIG. 2A schematically presents construction details of one exemplary fire wrap panel of an exemplary fire protection system embodiment;

FIG. 2B schematically presents seaming details of the exemplary fire wrap panel of FIG. 2A;

FIG. 2C schematically presents first edge construction details of the exemplary fire wrap panel of FIG. 2A;

FIG. 2D schematically presents second edge construction details of the exemplary fire wrap panel of FIG. 2A;

FIG. 3A schematically represents an extended exemplary fire wrap panel embodiment constructed by detachably joining together a number of individual fire wrap panels having a construction like that shown in FIG. 2A;

FIG. 3B provides details of one exemplary technique for detachably joining the individual fire wrap panels shown in FIG. 3A;

FIG. 3C schematically indicates the use of a plurality of detachably joined individual fire wrap panels to cover the roof and sides of a structure to be protected;

FIG. 4A shows one exemplary fire wrap panel support pallet of an exemplary fire protection system embodiment in a first orientation;

FIG. 4B shows one exemplary fire wrap panel support pallet of an exemplary fire protection system embodiment in a second orientation;

FIG. 4C schematically illustrates one exemplary fire wrap panel support pallet of an exemplary fire protection system embodiment having attached fire wrap panels and residing in both an unfolded (flat) and roof pitch-adjusted orientation;

FIG. 5A shows one exemplary fire wrap panel support pallet of an exemplary fire protection system embodiment having attached and folded fire wrap panels, wherein the pallet resides in an unfolded (flat) orientation, such as for storage or transport;

FIG. 5B shows the fire wrap panel support pallet of FIG. 3A, wherein the pallet resides in a roof pitch-adjusted orientation as it would when straddling the roof peak of a structure to be protected;

FIG. 6A illustrates fire wrap material pre-formed to function as an exemplary chimney sock;

FIG. 6B shows the exemplary chimney sock of FIG. 6A being installed over the chimney of a structure to be protected;

FIG. 6C shows the exemplary chimney sock of FIG. 6A after installation and securement to the chimney of FIG. 6B;

FIGS. 7A and 7B generally indicate various steps involved with preparing for and initiating installation of an exemplary fire protection system embodiment to typical residential structures;

FIGS. 8A-8C illustrate the act of installing an exemplary fire wrap side panel to the side of an exemplary structure to be protected;

FIG. 9 shows exemplary fire wrap side panels partially installed to opposite sides of an exemplary structure to be protected;

FIGS. 10A-10C illustrate the steps of lifting an exemplary palletized fire wrap panel onto the roof of a structure having an exemplary fire wrap side panel already partially installed thereto, using the weight of the palletized fire wrap panel to secure a portion of the fire wrap side panel that overlies the roof of the structure, and unfolding the palletized fire wrap panel;

FIGS. 11A-11B schematically represent exemplary palletized fire wrap panels located on different portions of the roof of a structure to be protected, with the fire wrap panels in an unfolded position;

FIG. 12 depicts an exemplary palletized fire wrap panel located on the roof of a structure to be protected and partially unrolled;

FIGS. 13A-13C schematically represent the exemplary palletized fire wrap panels of FIGS. 11A-11B unrolled to cover a portion of the roof and opposing sides of the depicted structure;

FIGS. 14A-14B represent the operation of securing fire wrap rooftop panels and a cooperating fire wrap side panel to a structure to be protected;

FIGS. 15A-15D represent the operation of installing and securing additional fire wrap rooftop panels and a cooperating fire wrap side panel to the structure of FIGS. 14A-14B;

FIG. 16A-16B show a side view and end view, respectively, of the structure of FIGS. 15A-15D completely wrapped according to an exemplary fire protection system embodiment;

FIGS. 17A-17B represent optional steps of installing additional Fire-Resistant Material to an already wrapped structure to be protected;

FIGS. 18A-18B schematically represent an alternative exemplary embodiment of a palletized fire wrap assembly, wherein a fire wrap side panel is also connected to the pallet;

FIGS. 19A-19B depict the fire wrap panels associated with the pallet of FIGS. 18A-18B in an unrolled condition;

FIGS. 20A-20B are partially unfolded and fully unfolded views, respectively, of an alternative fire protection system embodiment in the form of an exemplary vehicle fire shelter for use in protecting a vehicle against damage from a wildfire;

FIGS. 21A-21B are alternate views showing a representative vehicle located atop the unfolded vehicle file shelter of FIG. 20A; and

FIGS. 22A-22E illustrate possible exemplary steps for securing the exemplary vehicle fire shelter of FIGS. 20A-20B around a vehicle.

### DETAILED DESCRIPTION OF THE EXEMPLARY EMBODIMENTS

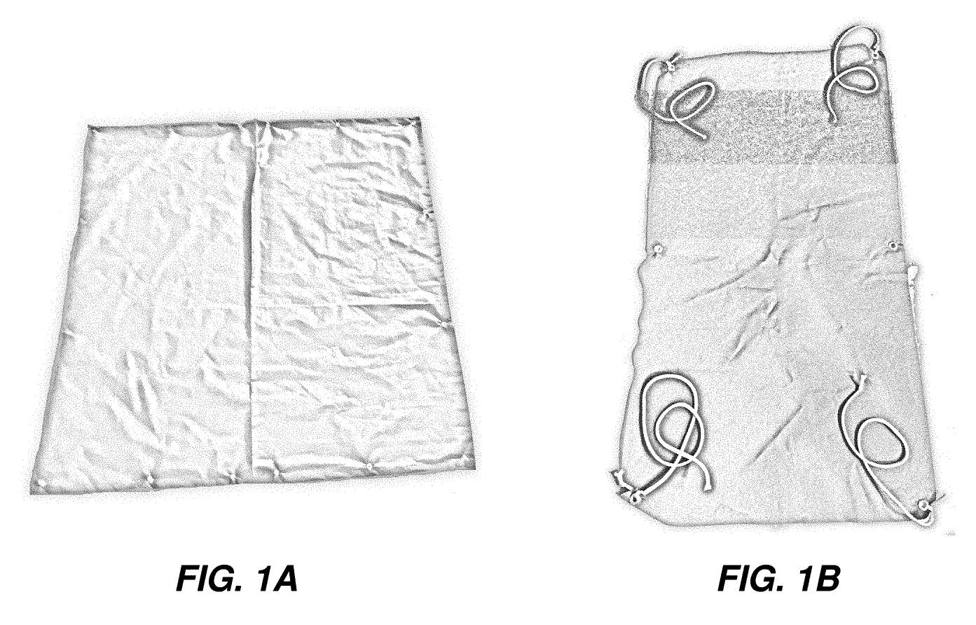

As described above, exemplary fire protection system embodiments described herein will generally include a plurality of fire wrap panels, which may be provided in different shapes and/or sizes and may or may not be palletized. One exemplary fire wrap panel is shown in FIG. 1A. A larger fire wrap panel is depicted in FIG. 1B, the larger panel being comprised of a pair of smaller panels that have been detachably joined along one edge.

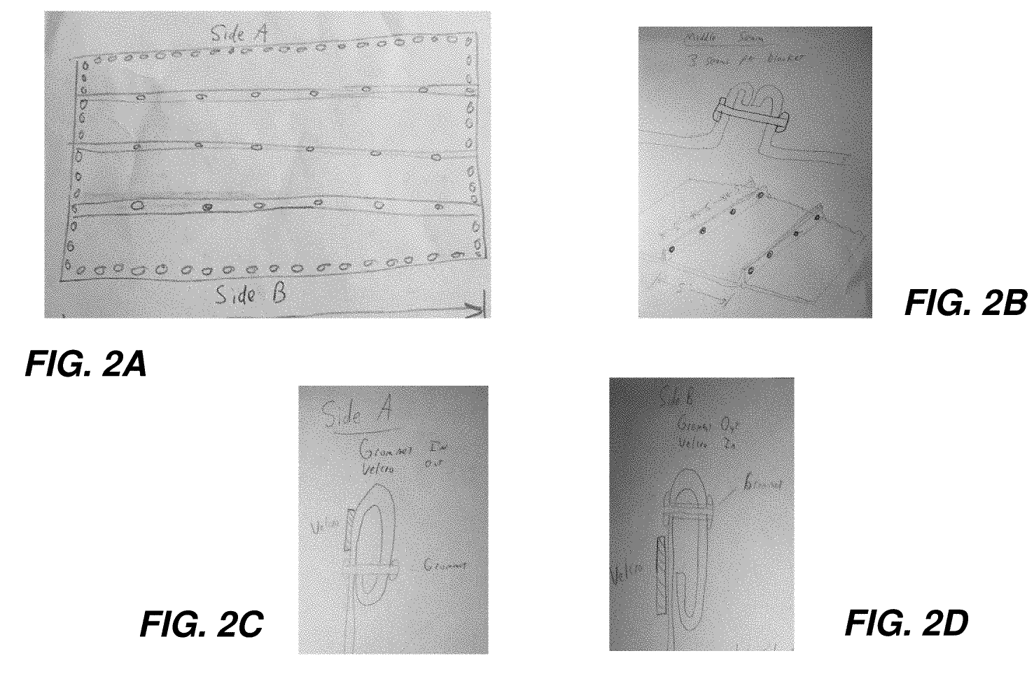

As can be observed in FIG. 2A, an exemplary fire wrap panel may be provided with a plurality of grommets or similar securing points, which may optionally occur along reinforced seams, ribs, etc. FIG. 2B is illustrative of one exemplary technique for detachably connecting an exemplary fire wrap panel between a pair of adjacent fire wrap panels, such that the panel in question becomes a middle or inner panel of a larger, composite fire wrap panel. For example, bolts, and/or heat-resistant cord, wire, cable ties (e.g., zip ties) or other releasable/removable fasteners may be placed through the grommet holes of the adjacent fire wrap panels as shown to detachably connect the panels to one another.

Exemplary techniques for finishing the edges of an exemplary fire wrap panel are shown in FIGS. 2C-2D. As can be observed, in these exemplary embodiments, opposite edges of the fire wrap panel of FIG. 2A are identified as Side A and Side B, respectively. The edges are folded over and sewn or otherwise joined to the remainder of the fire wrap panel to form a strengthened connection point, and a grommet extends through the fold to provide a passageway for a removable fastener that can be used to join the edge of one fire wrap panel to the edge of another fire wrap panel. In this exemplary embodiment, a hook and loop fastener element (e.g., Velcro®) is also located along the edges of Side A and Side B of the exemplary fire wrap panel to further facilitate detachable connection and sealing of adjacent panel edges. When present, individual hook and loop fastener elements may be periodically located along a panel edge, or a hook and loop fastener element may extend continuously along the panel edge. In an alternative embodiment, a zipper may also or instead be provided to facilitate the detachable connection of fire wrap panels.

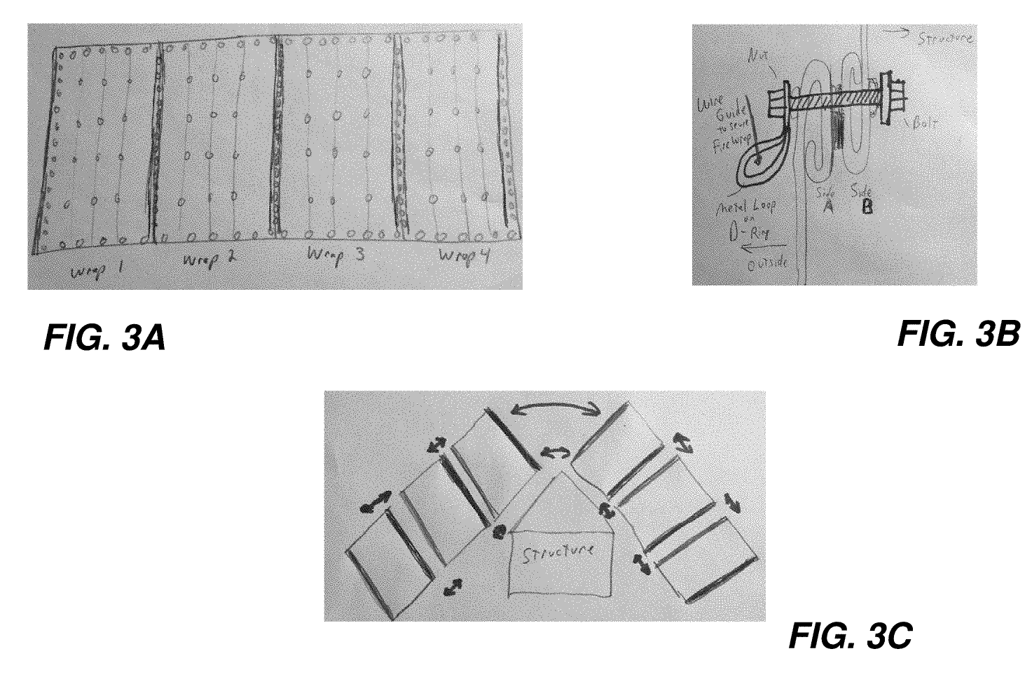

Referring now to FIG. 3A, a composite fire wrap panel comprised of four smaller and detachably connected fire wrap panels, may be observed. The connection of fire wrap panels in such a manner allows for a larger coverage area, as may be needed for certain structures.

FIG. 3B further illustrates the exemplary technique for connecting adjacent fire wrap panel edges initially described above with respect to FIGS. 2A-2D. In FIG. 3B, it can be seen that the folded Side A edge of one exemplary fire wrap panel is located to the folded Side B edge of an adjacent fire wrap panel, such that the respective hook and loop elements present on each fire wrap panel are in gripping communication. Fasteners—in this case bolts and nuts—are also represented as passing through the grommets of each of the fire wrap panels so as to securely but detachably connect Side A of one fire wrap panel to Side B of the other, adjacent, fire wrap panel. As also illustrated in FIG. 3B, a connecting element such as a wire loop, D-ring, etc., may also be secured to one or both of the connected fire wrap panels to provide a point of connection for a cable, rope or some other means of securing the fire wrap panels to a structure to be protected, to the ground, etc. Other means for connecting panels may additionally or instead be used, such as, but not limited to, the cord, wire and cable ties mentioned above.

FIG. 3C represents the modularity of exemplary fire protection system embodiments according to the application. More specifically, FIG. 3C illustrates how a plurality of individual fire wrap panels may be detachably connected to form a larger pair of fire wrap panels (or a larger single fire wrap panel) that is of sufficient size to properly cover an area of the roof and sides of a given structure. The modularity of the exemplary fire protection system embodiments described and explained herein allows the systems to adapt to structures of various shapes and/or dimensions.

At least certain fire wrap panels of exemplary fire protection system embodiments may be palletized. That is, at least some exemplary fire protection system embodiments will include fire wrap panels that are attached to specialized fire wrap support/installation pallets that are adapted for placement on the roof of a structure to be protected.

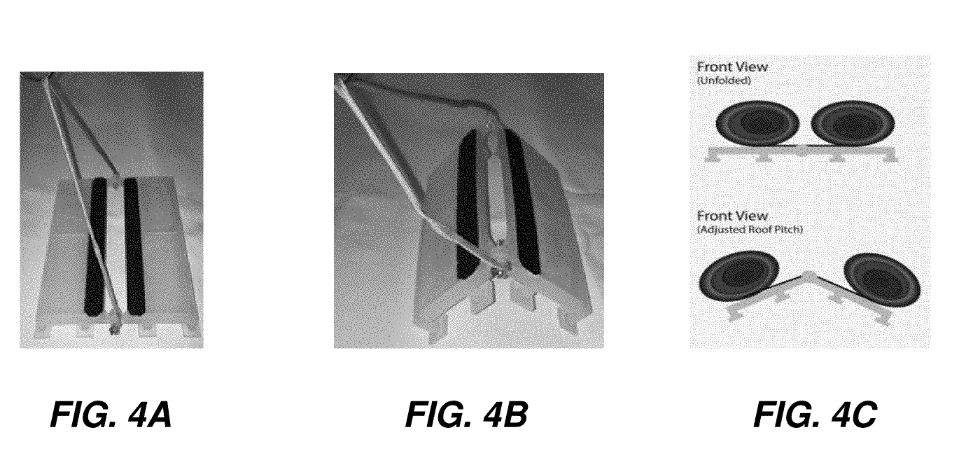

FIGS. 4A-4B depict one exemplary embodiment of a pallet for use with the exemplary fire protection system embodiments described herein. As shown, this exemplary pallet is a hinged structure with a pair of fire wrap panel supporting platforms arranged on opposite sides of the hinged connection. An attachment mechanism is provided for attaching fire wrap panels to each of the fire wrap panel supporting platforms. The attachment mechanism may permit the positions of the fire wrap panels to be adjusted relative to the pallet to provide for additional fire wrap panel positional adjustability and corresponding conformity to any roof on any structure. This exemplary pallet also includes lower legs that are adapted to support the pallet on the roof of a structure to be protected, however, such legs may be absent from other pallet embodiments. The pallets may be of metallic construction, but may also be comprised of other sufficiently strong materials that are preferably fire proof or fire resistant.

FIG. 4B illustrates particularly well the adjustable positioning afforded by the hinged construction of this exemplary pallet. The hinged construction allows the angle between the fire wrap panel supporting platforms to be adjusted between, for example, 0 and 90 degrees, so as to permit the pallet to rest securely on the roof of virtually any structure to be protected when the pallet is located to straddle the peak of the roof. The degree of adjustability may be more or less than 0 to 90 degrees in other embodiments.

FIG. 4C schematically illustrates a pair of fire wrap panels (which may be individual or composite panels) attached to the fire wrap panel supporting platforms of the pallet of FIGS. 4A-4B. In the upper representation of FIG. 4C, the pallet is arranged in a substantially flat orientation such as might be common during storage, transport, or staging prior to lifting and placement on the roof of a structure to be protected. The lower representation of FIG. 4C shows the pallet and associated fire wrap panels in an angled orientation such as would be common subsequent to placement of the pallet on the roof of a structure to be protected. In both representations of FIG. 4C, the associated fire wrap panels may be secured in a rolled-up condition, such that no inadvertent unrolling is possible.

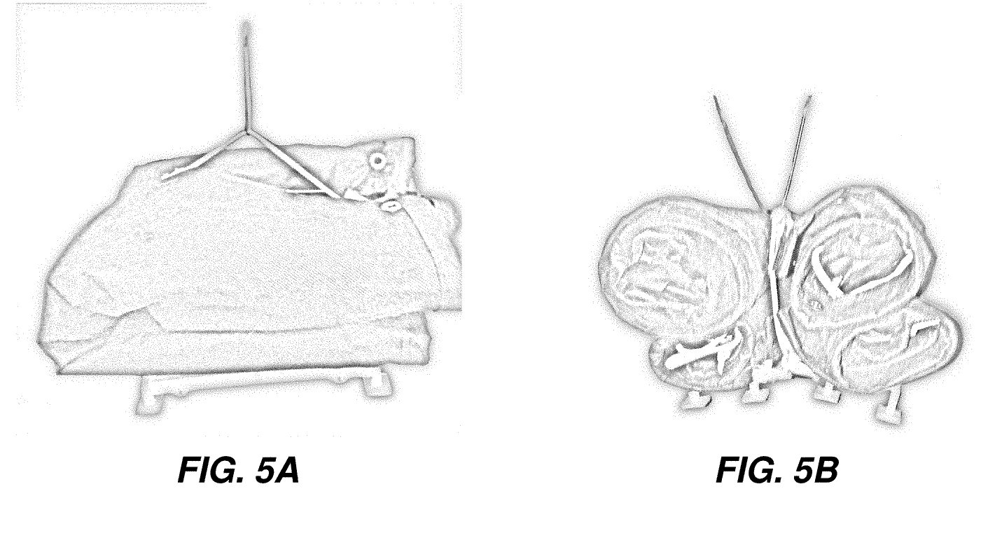

FIGS. 5A-5B further illustrate a possible appearance of exemplary fire wrap panels attached to an exemplary pallet, such as for example, the pallet shown in FIGS. 4A-4B. The fire wrap panels are shown in a rolled up and folded over state in FIGS. 5A-5B, which is a state that facilitates storage, transport, and initial placement of the pallet on the roof of a structure to be protected.

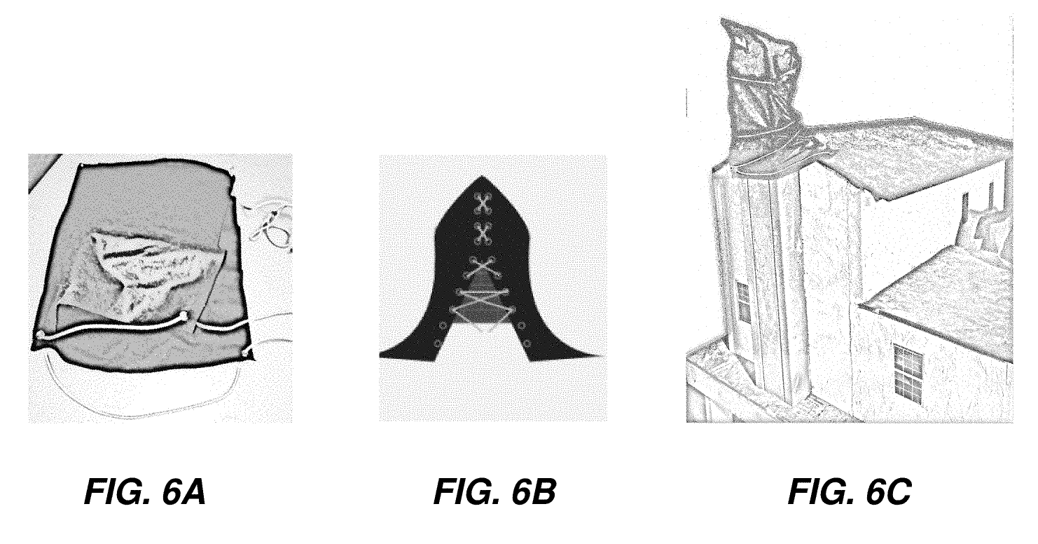

FIGS. 6A-6C are representative of one exemplary embodiment of a specialized fire wrap component that can be used to protect projecting features of a structure to be protected. In this particular example, the component is in the form of a chimney sock designed to be placed over an upwardly extending chimney and subsequently detachably connected a fire wrap panel covering a portion of the roof or a side of the structure. Other specialized components are also possible, such as those used for, without limitation, covering a vent pipe, antenna, satellite dish, or other projecting feature associated with a structure to be protected. When such a specialized fire wrap component is necessary, the component may be pre-formed offsite, or may be wholly or partially created onsite.

In the particular case of the chimney sock of FIGS. 6A-6B, it can be seen that a section of fire wrap material has been cut to shape and joined to form a sock shape with one open side that can be slid over the top of the chimney. After being pulled downward to the proper point, the open side of the chimney sock is then closed by detachably connecting opposing fire wrap material edges along the opening. This may be accomplished by way of cables, ropes and/or any of the other fasteners mentioned above. The closed chimney sock is then secured to the chimney and to a rooftop fire wrap panel as shown in FIG. 6C.

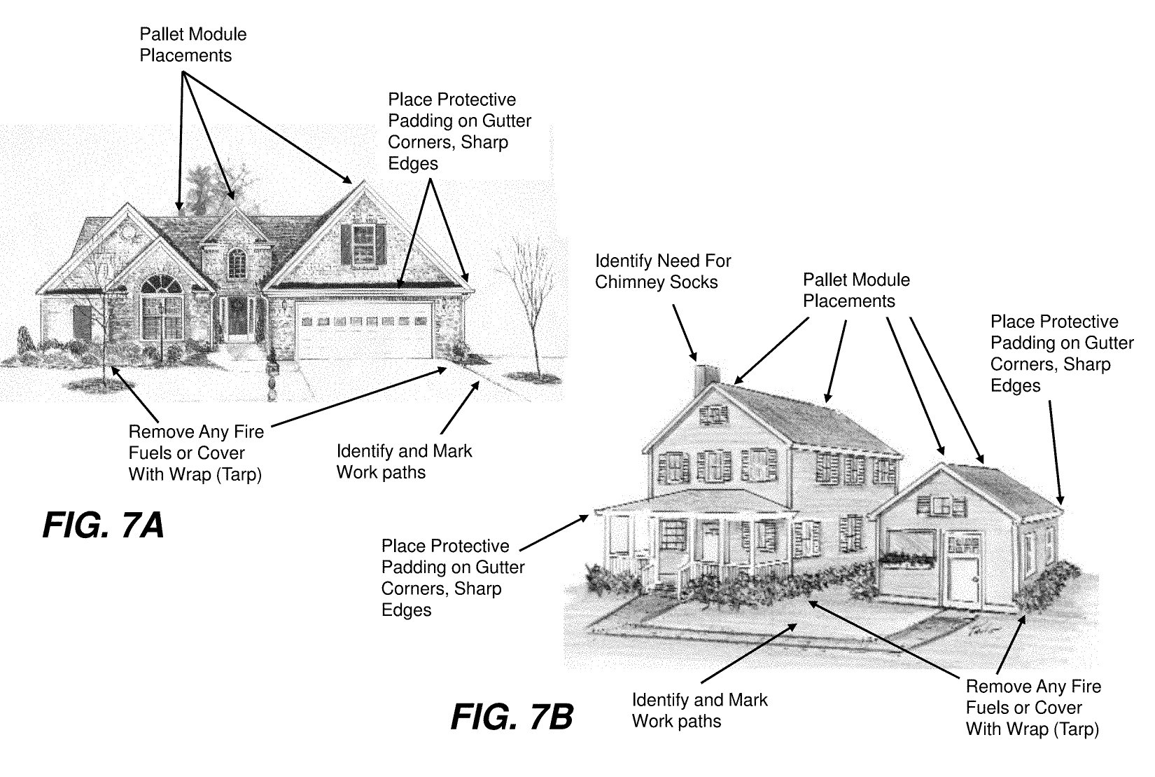

FIGS. 7A-7B depict some of the possible issues to be considered and steps to be taken prior to and during the installation of an exemplary fire protection system embodiment to exemplary residential structures. As indicated, some of these considerations and steps may include, without limitation, identifying and marking work paths for use during installation and subsequent removal of fire protection system components; removing any fuels or other combustible materials from near the structure or noting the presence and location(s) of such material such that the same may be covered along with the associated structure; placing protective padding on the gutter corners and other sharp edges of the structure; and identifying the rooftop locations for placement of palletized fire wrap panels. It should be noted that at least some of the considerations and steps represented in FIGS. 7A-7B may be optional.

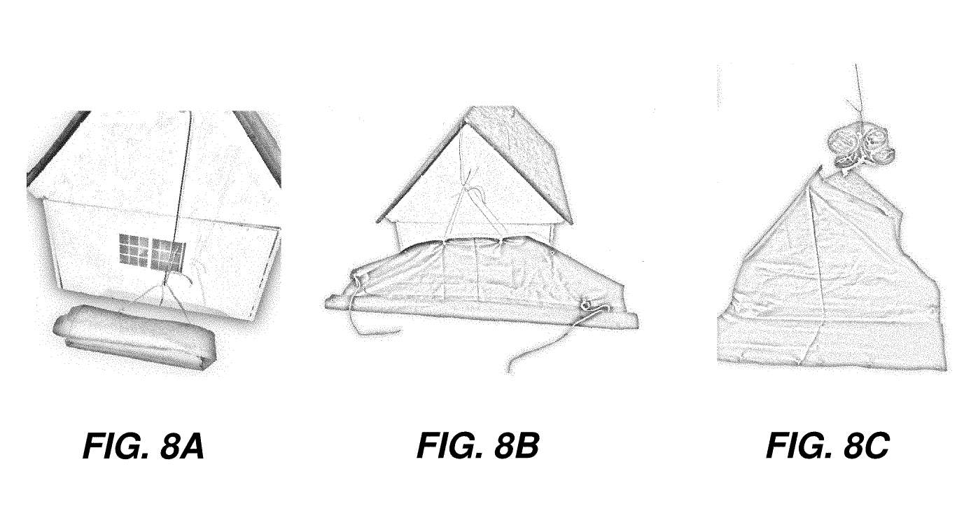

FIGS. 8A-8C represent one exemplary technique for installing an exemplary fire wrap side panel to a side of a structure to be protected. Initially, a fire wrap side panel is placed on the ground on the side of the structure to which the panel will be installed. As shown in FIG. 8A, the fire wrap side panel may be transported in a stored position (i.e., rolled and folded), but such is not essential. Referring now to FIG. 8B, the fire wrap side panel is next unfolded and lifted by way of attached guide wires or other similar elements using a bucket truck or another suitable lifting apparatus such that the upper end of the fire wrap side panel may be caused to overlie the adjacent peak of the structure roof. After the fire wrap side panel has been lifted and initially located, the fire wrap side panel is caused to overlap a portion of the roof and to fully cover the structure side of interest, whereafter the fire wrap side panel is secured to the structure by the guide wires or by any of the other means described above, as illustrated generally in FIG. 8C. Excess fire wrap side panel material may be rolled out on the ground and away from the structure as shown.

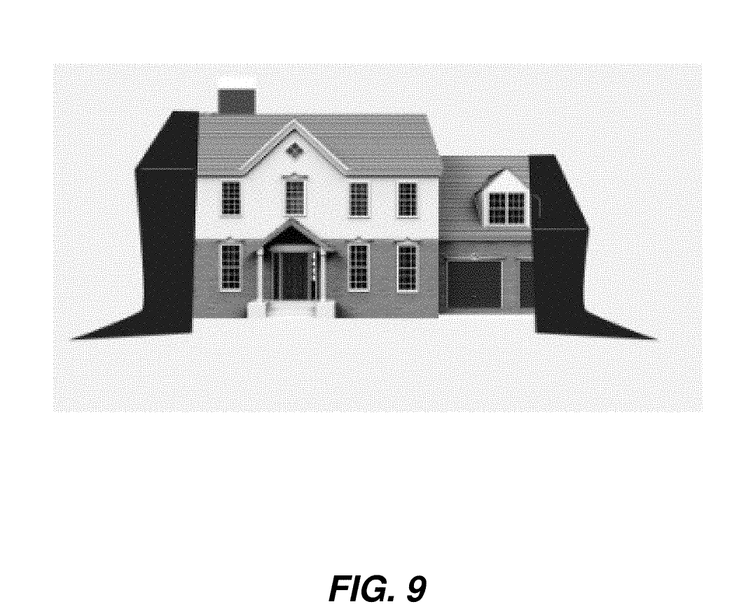

FIG. 9 schematically depicts opposite sides of a structure of interest covered by a fire wrap side panel. The fire wrap side panels of FIG. 9 may be installed as described above with respect to FIGS. 8A-8C.

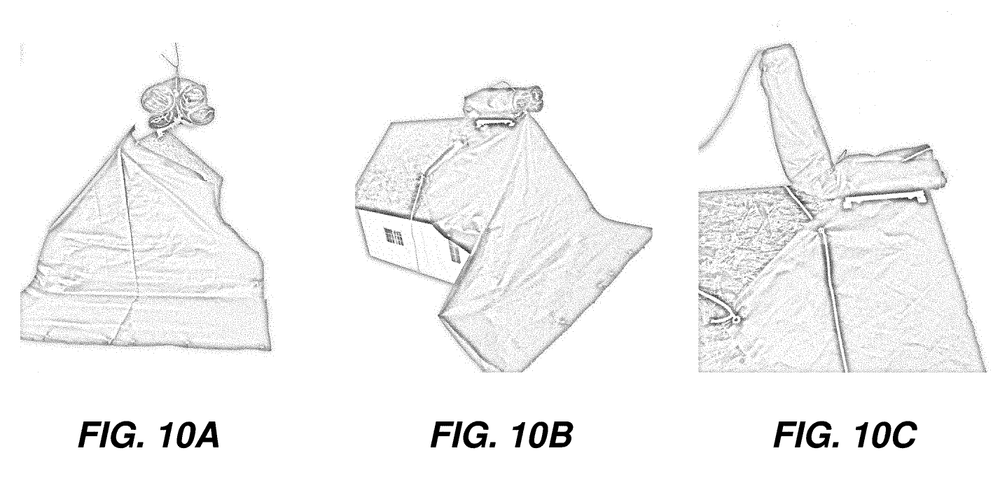

FIGS. 10A-10C illustrate the lifting and initial placement of palletized fire wrap panels on the roof of a structure to which a fire wrap side panel has already been installed. As shown in FIG. 10A, a pallet with attached fire wrap panels is first lifted into position, such as by a bucket truck or another suitable lifting apparatus. The pallet is then lowered onto the roof as shown in FIG. 10B, so as to straddle the roof peak and to rest upon a portion of the already installed fire wrap side panel. In some embodiments, the pallet angle may be set and fixed by a user to match the pitch of a given roof prior to lifting and placement of the pallet onto the roof. In other embodiments, a pallet may be designed such that the pallet angle will automatically adjust to the roof pitch upon lowering of the pallet onto the roof of the structure. In any case, the weight of the pallet and the attached fire wrap panels will assist in retaining the fire wrap side panel. As depicted in FIG. 100, once the pallet is properly positioned on the roof, the fire wrap panels may be unfolded in preparation for unrolling and further installation.

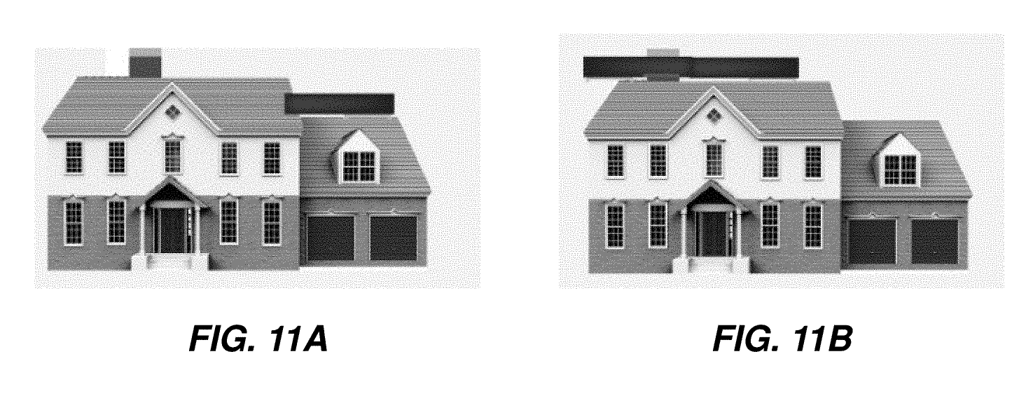

Unfolded fire wrap panels associated with several different pallets placed on the roof of a representative residential structure are schematically represented in FIGS. 11A-11B. It can also be better understood from FIGS. 11A-11B how palletized fire wrap panels may be placed in different locations along the roof of a structure to be protected to provide full coverage of the roof and opposing sides of the structure upon unrolling and detachable connection of the fire wrap panels.

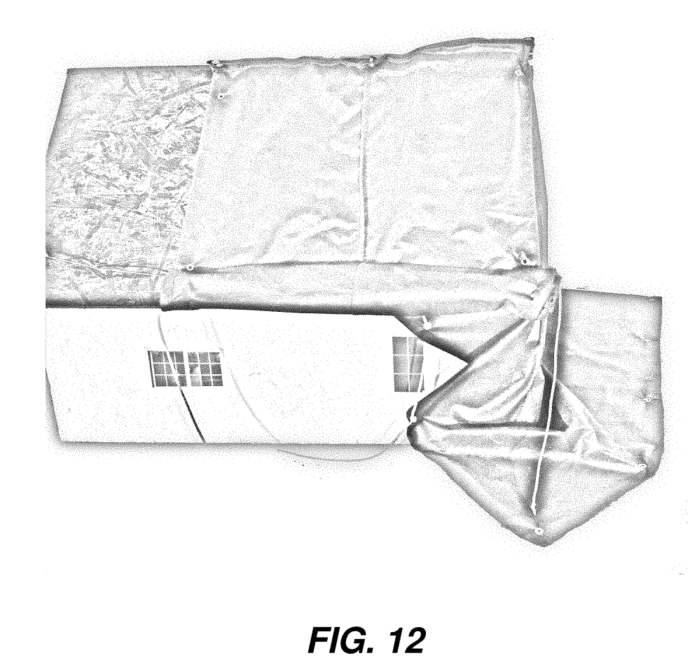

Initial unrolling of a palletized fire wrap panel is depicted in FIG. 12. The particular fire wrap panel being unrolled in FIG. 12 is attached to a pallet that has been placed near one end of a structure. Consequently, it can also be observed that the palletized fire wrap panel will overlap a portion of the previously installed fire wrap side panel that overlies the roof of the structure. This helps to ensure that there are no openings between fire wrap panels into which firebrands may enter.

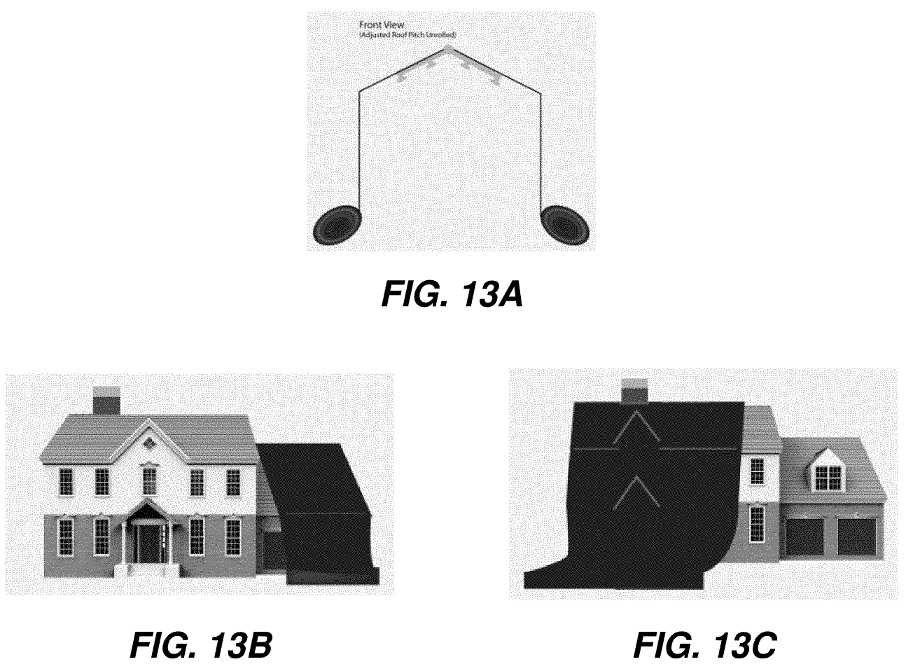

FIGS. 13A-13C schematically illustrate the unrolling of palletized fire wrap panels to ground level. It can be seen that at least a portion of the roof and opposing sides of the structure are covered during the unrolling process. Excess fire wrap panel material at ground level may be further unrolled away from the structure and staked or otherwise secured to the ground. Ground level combustible materials may also be covered by excess fire wrap panel material in some cases.

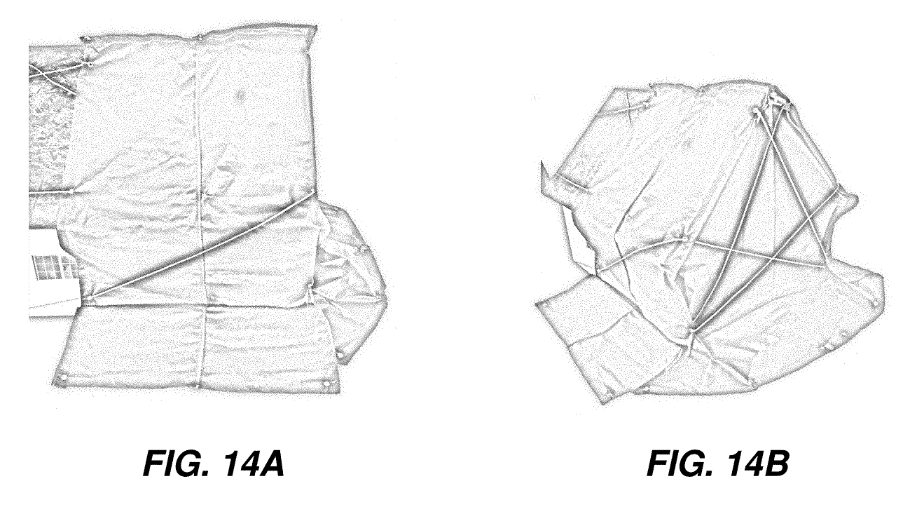

Initial securing of fire wrap panels to a structure is represented in FIGS. 14A-14B. In this case, an installed fire wrap side panel and a pair of overlapping palletized fire wrap panels extending downward from the roof are secured by cables to the structure and to each other. Other techniques for securing the fire wrap panels are also possible, whether through the use of cables or otherwise, and the exemplary technique shown in FIGS. 14A-14B (and any other figures) is not to be considered limiting.

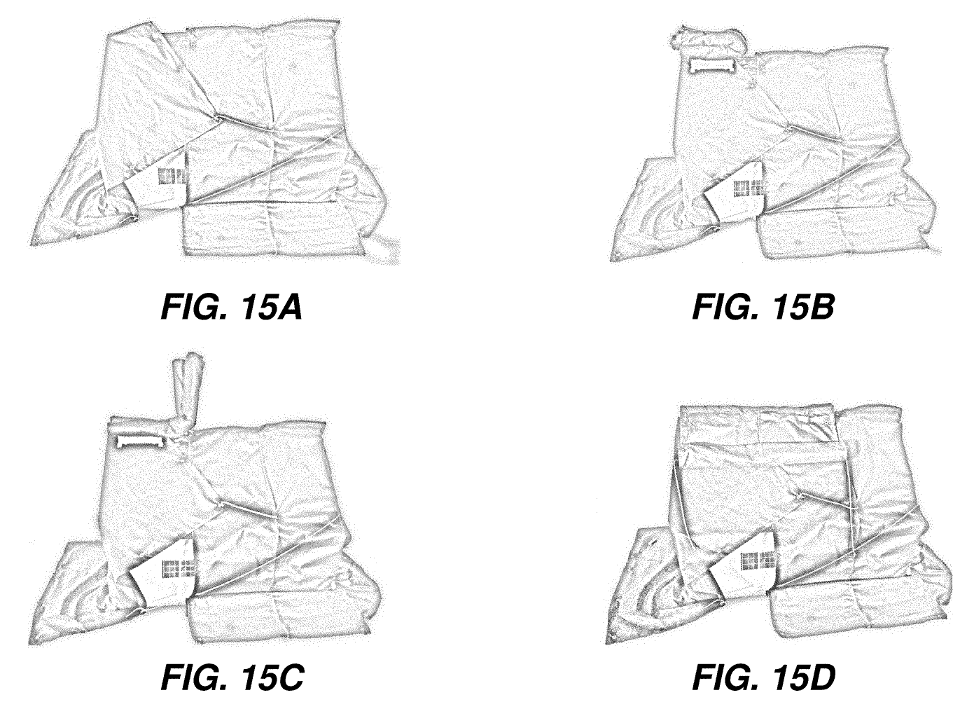

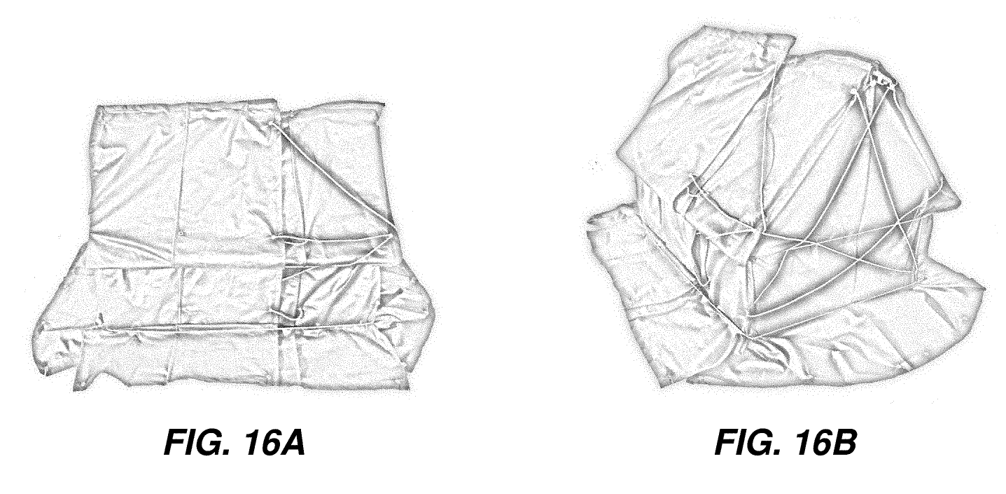

FIGS. 15A-15D and 16A-16B illustrate the installation of a further fire wrap side panel and the rooftop placement and deployment of additional palletized fire wrap panels as necessary to cover the entire structure to be protected. As discussed above, with respect to FIGS. 14A-14B, the additional fire wrap panels are again secured to the structure and to each other, so as to ultimately form a tightly fitting wrap that envelops the entire structure with no portions of the structure exposed and no openings between panels into which firebrands may intrude. Stakes or weighted objects such as, for example, dirt or rocks, may be used to secure those portions of the fire wrap panels that reside on the ground surrounding a structure. Extending the fire wrap panels along the ground and away from the structure a sufficient distance, may also act as a further buffer against fire reaching the structure.

As depicted in FIGS. 16A-16B, the fully wrapped structure is highly protected against the heat and firebrands generated by wildfires, and the fire wrap panels are secured in a manner that eliminates or at least greatly reduces their displacement by wind. Consequently, the fire panel wrapped structure is rendered highly resistant to damage by a wildfire.

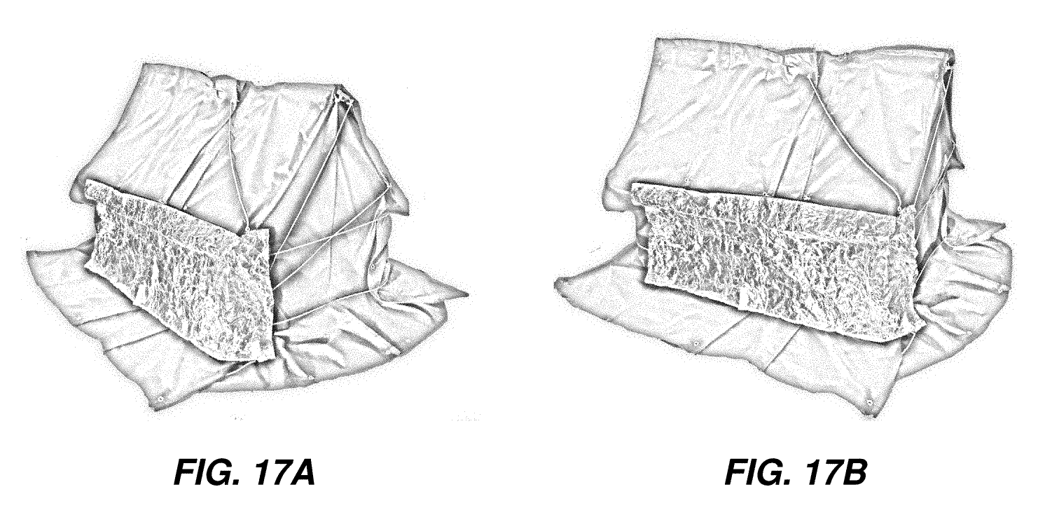

While a fire panel wrapped structure is highly resistant to damage by a wildfire, it is also possible to install additional fire wrap panels and/or other fire protection barrier material to an already wrapped structure for even more protection. One such exemplary installation is represented in FIGS. 17A-17B, where an additional fire protection material has been installed over the installed fire wrap panels along one side of the wrapped structure. In this particular example, the additional fire protection material is depicted as having a composition/construction that is different than that of the previously installed fire wrap panels. However, in other embodiments, additional fire wrap panels or other protective elements of like composition/construction may be placed over the previously installed fire wrap panels.

When used, additional fire protection material would typically, but not necessarily, be installed/attached along the side of the structure that a fire is approaching, or perhaps along the side of a structure having trees, fuel sources (e.g., a parked vehicle) or other combustible materials nearby. The added fire protection material may be provided in panels having grommets that are located to cooperate with the grommets of the already installed fire wrap panels, so as to facilitate installation and retention of the additional fire protection material.

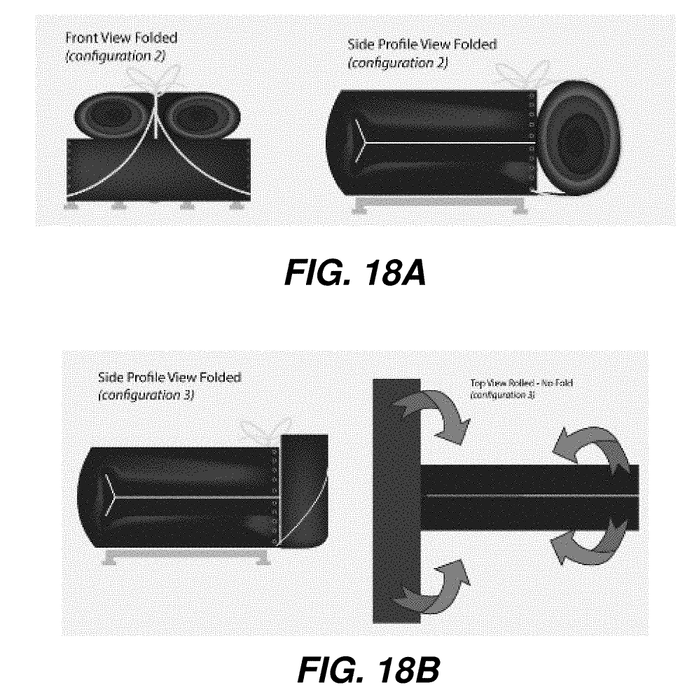

FIGS. 18A and 18B schematically represent an alternative exemplary embodiment of palletized fire wrap panels. This exemplary embodiment differs from the exemplary palletized fire wrap panel embodiments previously shown and described, in that this exemplary embodiment also includes a fire wrap side panel that is attached to the pallet. For example, and as shown, a fire wrap side panel may be attached to the pallet at one end of the fire wrap panels that are provided for unrolling across the roof and down the opposing sides of a structure to be protected. The additional fire wrap side panel is shown to be oriented substantially perpendicularly to the other palletized fire wrap panels such that when the pallet is placed on the roof of the structure at one end thereof, the fire wrap side panel may be easily unrolled to cover one end (side) of the structure.

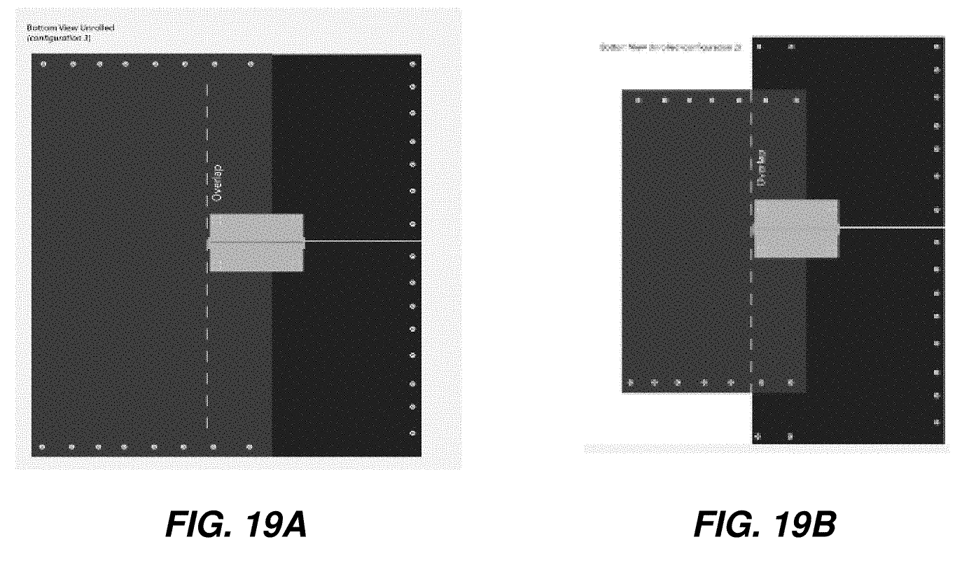

The three palletized fire wrap panels of FIGS. 18A-18B are schematically depicted in an unrolled state in FIG. 19A, with the fire wrap side panel located on the left. FIG. 19B is an alternative embodiment provided to illustrate the possible variability of the relative fire wrap panel sizes as needed based on the given structure to be protected.

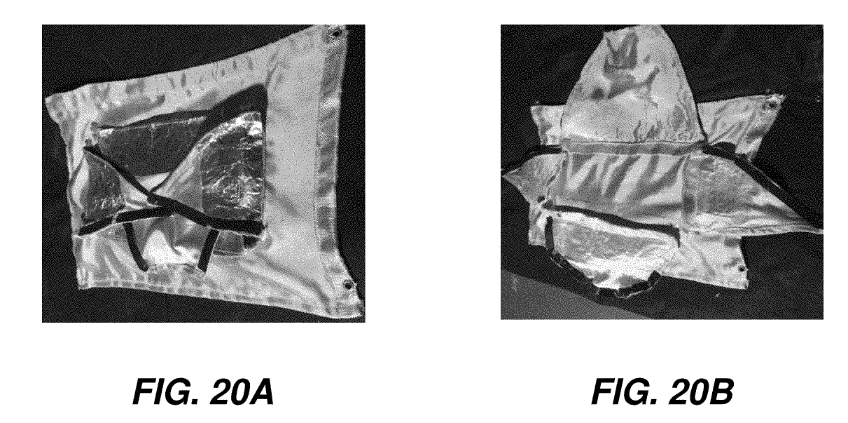

An alternative embodiment of a fire protection system in the form of an exemplary vehicle fire shelter is presented in a partially and fully unfolded state, respectively, in FIGS. 20A-20B. As shown, this exemplary vehicle fire shelter is comprised of a specialized fire resistant cover that is designed to completely enclose a vehicle when fully installed thereto. Vehicle fire shelters of different sizes and shapes may be provided, whether to cover specific vehicles or just relative size classes of vehicles. A given vehicle fire shelter may also offer at least some size adjustability to fit as many different types and sizes of vehicles as possible.

The fire-resistant cover of the exemplary vehicle fire shelter embodiment shown in FIGS. 20A-20B includes a base panel to which are connected four upwardly extendable side panels that, when fully and properly installed, are functional to fully enclose a vehicle and to protect the vehicle against damage from fire, smoke, firebrands, and convective and radiant heat. The four upwardly extendable side panels generally include a front panel, a driver side panel, a passenger side panel, and a rear panel. One of the side panels—the passenger side panel in this example—may also act as a roof covering panel.

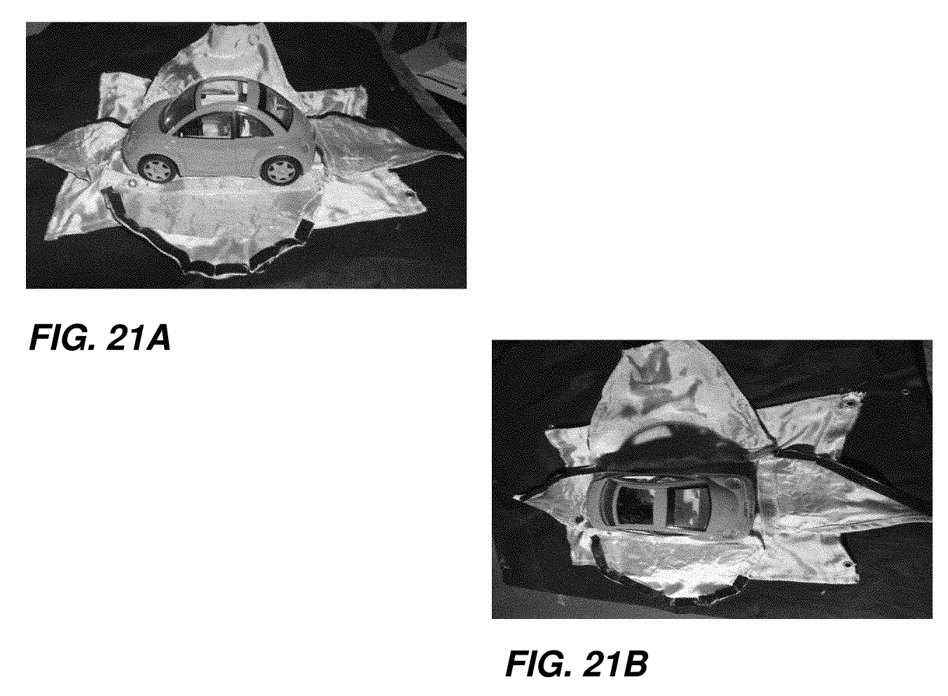

The initial step (subsequent to opening and unfolding of the cover) of installing the vehicle fire shelter to a vehicle is represented in the alternate views of FIGS. 21A-21B, where the vehicle has been driven onto or towed onto the unfolded cover so as to be centrally located between the four upwardly extendable side panels. Markings may be provided to aid in proper vehicle positioning. With the vehicle properly positioned, the remainder of vehicle fire shelter installation may take place.

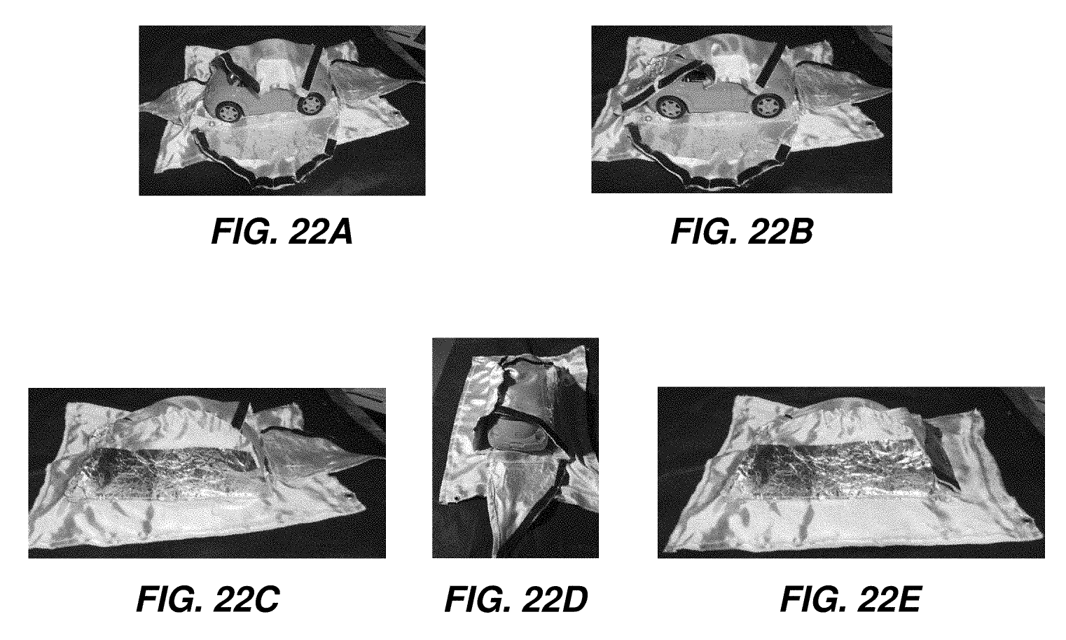

The various steps associated with further enclosing of a vehicle within the exemplary vehicle fire shelter of FIGS. 20A-20B are represented in FIGS. 22A-22E. Further installation of this particular exemplary vehicle fire shelter using this particular exemplary enclosing method, initially includes extending the passenger side panel of the cover upward and over the roof of the vehicle (FIG. 22A). This step is followed by securing the front panel to the passenger side panel along adjacent edges thereof (FIG. 22B), and then raising the driver side panel and securing it to the front panel and passenger side panel (FIGS. 22C-22D). The rear panel is then raised and secured to the driver side and passenger side panels to fully enclose the vehicle (FIG. 22E). Once all of the shelter panels are secured to one another, cross tie downs located along the shelter cover near corners of the enclosed vehicle may be fastened and tightened to ensure a tight-fitting shelter that is resistant to displacement in high wind conditions.

As shown in FIG. 22E, the base portion of the shelter may be extended outward away from the vehicle and placed flat on the ground to form a further fire barrier. The base may also be further secured by staking or by the placement thereon of dirt, rocks, or other weighted items.

The panels of an exemplary vehicle fire shelter embodiment may be secure to one another in various ways. For example, a fire-resistant hook-and-loop fastener system may be located along the edges of the flaps for this purpose. Alternatively, or in addition, zippers and/or snaps may be provided to secure the flaps. When zippers are used, the zippers may be provided with leads or leashes that facilitate reaching and zipping the zippers.

As with the exemplary structure fire protection system embodiments described above, additional fire protection material may also be applied to one or more surfaces/locations of an exemplary vehicle fire shelter embodiment, such as for example, to further protect particularly flammable components like tires, bumpers, and fuel tanks (see e.g., FIGS. 22C and 22E). Vehicle fire shelter embodiments are also not limited to use with cars, SUVs, trucks, minivans, etc., but may also be designed and used for protecting motorcycles, trailered boats, ATVs, snowmobiles, tractors, and other recreational and utility vehicles/equipment.

Various materials may be used to construct the fire wrap panels and other components of an exemplary structure fire protection system and vehicle fire shelter. For example, and without limitation, fire wrap panels and other fire protection system components may be constructed from heavy-duty welding blankets or welding blanket material with a working temperature preferably above 1,500 degrees Fahrenheit; bronze silica fabric having a weight of, for example, 18-36 oz./yd.; carbon fiber felt having a weight of, for example, 15-25 oz./yd., and a thickness of, for example, approximately 0.25 inches; vermiculite; silicone coated fiberglass; thin aluminum glued onto fabric; and combinations of some or all of said materials. The use of such materials and combinations of such materials having different properties is also possible, as is the use of other fire-resistant materials and combinations of materials.

While the foregoing disclosure describes the use of exemplary fire protection system embodiments to protect structures against damage from “wildfires”, it is to be understood that no inventive system or method embodiment is so limited. That is, while wildfires are the predominant type of fire against which a structure is likely to be protected using an exemplary system or method, exemplary system and method embodiments may also be used to protect a structure against damage from any external fire where there is sufficient forewarning to permit installation of the required fire protection system components prior to arrival of the fire. Therefore, the term wildfire, as used herein, is to be understood as encompassing such other fires. Furthermore, while the foregoing disclosure describes the use of exemplary fire protection system embodiments to protect residential structures against fire damage for purposes of illustration, exemplary fire protection system embodiments may obviously also be used to protect commercial or other non-residential structures from fire damage.

While certain exemplary embodiments are described in detail above, the scope of the invention is not considered limited by such disclosure, and modifications are possible without departing from the spirit thereof, as evidenced by the following claims:

What is claimed is:

1. A modular fire protection system for protecting a structure against damage from an external fire, comprising:
a plurality of detachably connectable fire wrap panels constructed from a fire-resistant material, the panels for covering different portions of a structure to be protected;
at least one of the plurality of detachably connectable fire wrap panels being a palletized fire wrap panel that includes and is attached at one end to a hinged supporting pallet that is adaptable to the pitch of a roof of the structure when located to straddle the peak thereof; and
means for connecting the plurality of detachably connectable fire wrap panels to one another and for securing the detachably connected fire wrap panels to the structure.

2. The fire protection system of claim 1, further comprising at least one generally sock-shaped fire protection component for covering a projection such as, but not limited to, a chimney, vent, antenna or satellite dish associated with the structure, the generally sock-shaped fire protection component adapted for detachable connection to at least one of the plurality of fire wrap panels.

3. A vehicle fire shelter for protecting a vehicle against damage from an external fire, comprising:
a cover constructed from a fire-resistant material, the cover further comprising a base panel and four upwardly extendable side panels;
a closure mechanism for detachably connecting adjacent edges of the upwardly extendable side panels when the upwardly extendable side panels are raised to cover corresponding sections of the vehicle; and
a plurality of cross-ties extending from the cover at locations near corners of the vehicle, the cross-ties being detachably connectable to further secure the connected panels of the cover to the vehicle.
